(19) United States
(12) Patent Application Publication
(10) Pub. No.: US 2006/0071097 A1
(43) Pub. Date: Apr. 6, 2006

(54) Systems and methods for dispensing an anti-traction, mobility denial material

(75) Inventors: Rolf Glauser, San Antonio, TX (US); Errol M. Brigance, San Antonio, TX (US)

Correspondence Address: OLIFF & BERRIDGE, PLC, P.O. BOX 19928, ALEXANDRIA, VA, 22320, US

(73) Assignee: SOUTHWEST RESEARCH INSTITUTE, San Antonio, TX (US)

(21) Appl. No.: 10/948,317

(22) Filed: Sep. 24, 2004

(51) Int. Cl. B05B 7/04

(52) U.S. Cl. 239/433; 239/296; 239/340; 239/346; 239/419; 239/526

(57) ABSTRACT

Man-portable systems and methods for dispensing an anti-traction, mobility denial material on a target surface. In various exemplary embodiments, a method of dispensing an anti-traction material on a target surface includes providing a dry polymer powder to a first section of a dispensing nozzle, providing a water stream to a separate second section of a dispensing nozzle, and mixing the polymer powder with the water stream upon exit of the streams out of the first and second sections of the dispensing nozzle to form the anti-traction material on the target surface, the formed anti-traction material being a gel.

The U.S. Government has a paid-up license in this invention and the right in limited circumstances to require the patent owner to license others on reasonable terms as provided by the terms of U.S. Government Contract No. V674P-2995, Delivery Order No. 674-W10091, and U.S. Government Contract No. M67854-02-D-1087, Delivery Order No. 0001, awarded by the United States Marine Corps.

### BACKGROUND OF THE INVENTION

1. Field of Invention

This invention relates to a portable system and a method for dispensing an anti-traction, mobility denial material onto a surface.

2. Description of Related Art

Crowd and riot control is a concern for law officials at every level of government. Typical attempts of crowd control often depend upon physical force to subdue and disperse crowds. Such physical force includes batons, rubber bullets, water cannons, kinetic energy rounds and the like.

Non-lethal weapon systems now represent an important alternative for law enforcement officials and strategic defense purposes. Examples of non-lethal weapons include, but are not limited to, tear gas, flash grenades, acoustic guns, sticky foams, snare nets, stun guns, strobe lights, malodorants, and the like. However, these typical non-lethal controls have disadvantages. For instance, crowd barriers can be bulky, require advance planning to move them into place, require large storage areas when not in use, and can be destroyed or used as weapons by the crowd members, etc. Typical barriers may also be besieged by vehicles driven by crowd members.

Crowd controls such as tear gas and malodorants, although non-lethal, may still cause physiological and/or psychological injury to both law enforcement agents and crowd members. Further, tear gas and malodorants may not impede forward progress of determined rioters. Moreover, sticky foams are difficult to apply and may be difficult to remove once the crowd has dispersed.

### SUMMARY OF THE INVENTION

In view of the above, an anti-traction material (ATM) that impedes the mobility and access of personnel and/or vehicles to areas that are to be defended or protected may be desired. Such exemplary anti-traction materials are disclosed in U.S. patent application Ser. No. 10/727,615, which is incorporated herein by reference in its entirety. As disclosed in application Ser. No. 10/727,615, the anti-traction material generally includes at least a plurality of polymer or acrylic copolymer particles and water or other like substance. Generally, the polymer or acrylic polymer/copolymer particles are in a very fine dry powder-like form. Preferably, the anti-traction material is made by combining or mixing water with the acrylic polymer/copolymer powder at the time of application to a target surface. Following application on the target surface, and upon hydration of the acrylic polymer/copolymer particles, the anti-traction material typically produces a coherent, visco-elastic gel that resists vertical slump and displacement by gravitational forces and forces of foot and vehicle traffic.

However, if the acrylic polymer particle powder is mixed with water in the delivery system prior to dispensing, gellation and/or clogging of the parts of the delivery system will likely occur. Thus, water and the acrylic polymer particle powder are kept separated until dispensed.

This invention provides man-portable systems and methods for dispensing two or more materials, such as water and an acrylic polymer particle powder, onto a target surface to form an anti-traction, mobility denial material on the target surface.

This invention also provides man-portable systems and methods for controlling the dispensing flow rate of two or more material streams, such as, for example a water stream and an acrylic polymer particle powder stream forming an anti-traction material on the target surface, based at least on one or more of a size, shape, specific gravity and angle of repose of the acrylic polymer particle powder, operational characteristics of one or more devices providing motive power to flow the two or more material streams, target area characteristics, and target area size.

This invention also provides man-portable systems and methods that use high pressure air flow to provide or deliver a predetermined flow rate of an acrylic polymer particle powder to a discharge/mixing nozzle used for dispensing two or more material streams, such as a water stream and an acrylic polymer particle powder stream, onto a target surface to form an anti-traction, mobility denial material on the target surface.

This invention further provides man-portable systems for dispensing an anti-traction material, systems which are highly mobile and have compact storage space requirements.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of the systems and methods of this invention will be described in detail below, with reference to the following figures, in which:

FIG. 1 is a perspective view of an exemplary embodiment of a man-portable system for dispensing an anti-traction, mobility denial material on a target surface;

FIG. 2 is a schematic diagram of an exemplary embodiment of the man-portable system for dispensing an anti-traction, mobility denial material shown in FIG. 1;

FIG. 3 is a close-up view of the man-portable system for dispensing an anti-traction, mobility denial material shown in FIG. 1;

FIG. 4 is a close up view of the storage tank and discharge/mixing nozzle for the acrylic polymer particle powder of the man-portable system for dispensing an anti-traction, mobility denial material shown in FIG. 1;

FIG. 5 is a schematic diagram of the storage tank and discharge/mixing nozzle for the acrylic polymer particle powder of the man-portable system for dispensing an anti-traction, mobility denial material shown in FIG. 1; and

FIG. 6 is a perspective view of an exemplary embodiment of a discharge/mixing nozzle of the man-portable system to dispense the acrylic polymer particle powder and water stream shown in FIG. 1.

### DETAILED DESCRIPTION OF PREFERRED EMBODIMENTS

As discussed above, in one exemplary embodiment, the anti-traction material (ATM) includes two components: a dry polymer powder and water. When these components are properly mixed by weight, a liquid, gel-like substance is formed that, when applied to a surface, makes most surfaces very slippery and nearly impossible to negotiate by foot or wheeled vehicle. Thus, the ATM provides an effective, non-lethal means of controlling the movement of riotous crowds, for providing area denial, and for facilitating non-combatant evacuations in support of peacekeeping operations.

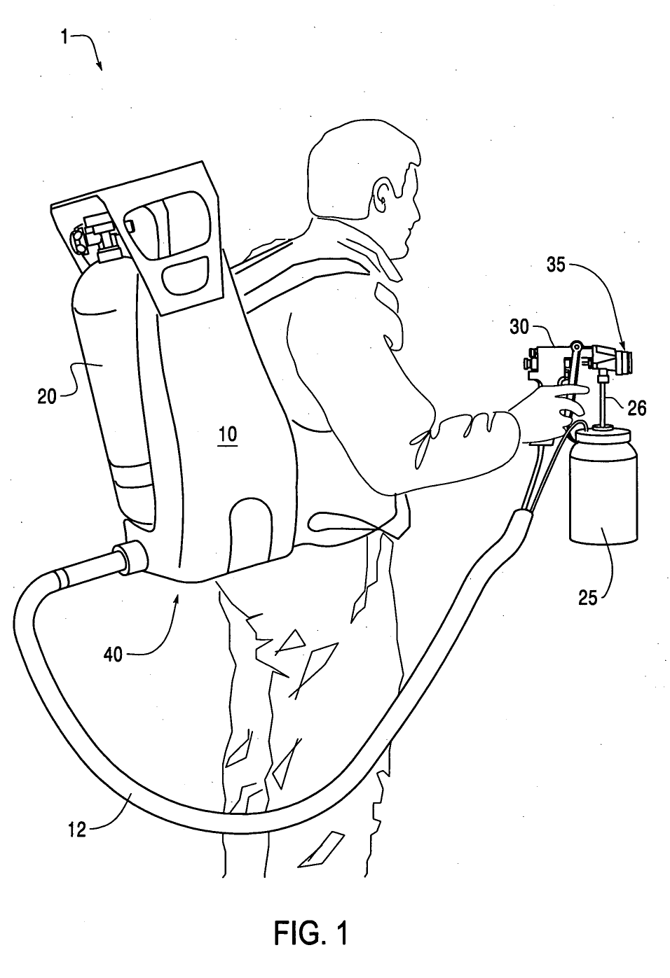

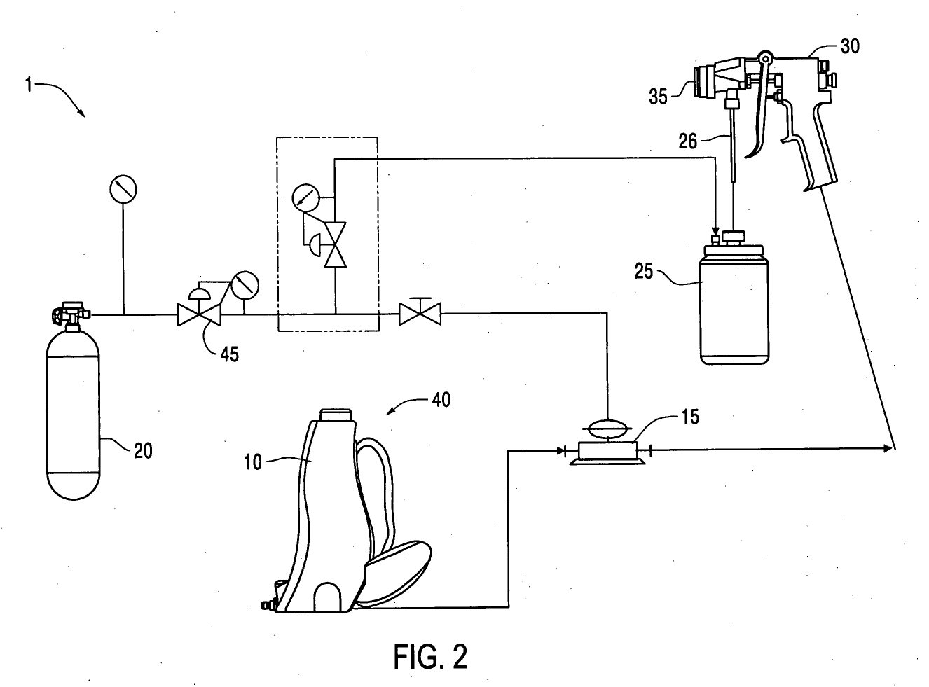

FIG. 1 is a perspective view of an exemplary embodiment of a man-portable system for dispensing an anti-traction, mobility denial material on a target surface according to this invention. FIG. 2 schematically illustrates the man-portable system shown in FIG. 1.

As shown in FIGS. 1 and 2, in various exemplary embodiments, the man-portable system 1 for dispensing the anti-traction, mobility denial material on the target surface may be housed in a backpack-type configuration which may include commercial-off-the-shelf (COTS) components, customized components and/or a combination thereof. In various exemplary embodiments, system 1 weighs less than about 75 pounds, including the water in a 5-gallon water holding tank 10 and the dry polymer powder in the dry polymer powder holding tank 25, and thus can be easily carried by a single individual.

In various exemplary embodiments, the man-portable system 1 for dispensing an ATM on a target surface is capable of dispensing a mixed stream of water/polymer powder forming the ATM to distances greater than about 25 feet, and preferably in a range of about 10 feet to about 20 feet. Further, in various exemplary embodiments, the man-portable system 1 can dispense a mixed stream of water/polymer powder over an effective area coverage of approximately 600 square feet (duration dependent), and may be able to empty a full load in about 4 minutes.

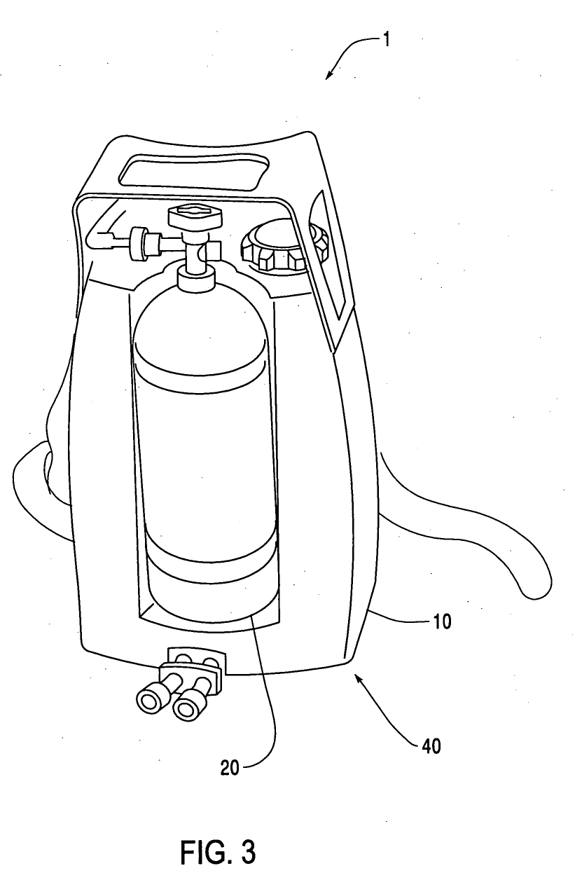

With reference to FIGS. 1-3, in various exemplary embodiments, the man-portable ATM dispensing system 1 includes a water holding tank 10, an air-operated water pump 15, a compressed gas bottle 20, a dry polymer powder holding tank 25, a dispenser gun 30 having a discharge/mixing nozzle 35, and associated hoses, valves and pressure regulating equipment attached. In various exemplary embodiments, the ATM dispensing system 1 is housed in, or configured to be carried within, a backpack-type carrier 40.

As discussed above, in an exemplary embodiment, most components of the man-portable ATM dispensing system 1 shown in FIGS. 1-3 are COTS components except the discharge/mixing nozzle 35, which was specially developed and fabricated by the system engineers according to this invention. The water holding tank 10 and the compressed gas bottle 20 are COTS components that were selected for their ergonomic design and suitability to the overall system. The COTS water holding tank 10 comes equipped with an air-operated pump 15, such as, for example, an air diaphragm pump, that is located beneath the water holding tank 10. The compressed gas bottle 20 supplies compressed air or other gas to the air-operated pump 15, which in turn pumps water from the water holding tank 10 down the hose 12 to the discharge/mixing nozzle 35 of the dispenser gun 30. In various exemplary embodiments, the compressed air is kept pressurized at about 4500 psi in the compressed air tank 20. Maintaining the system with such an initial pressure results in the system being available for multiple uses which will deplete the water holding tank 10 and/or the dry polymer powder holding tank 25 before the compressed air tank 20 is depleted and must be replaced, repressurized or otherwise recharged.

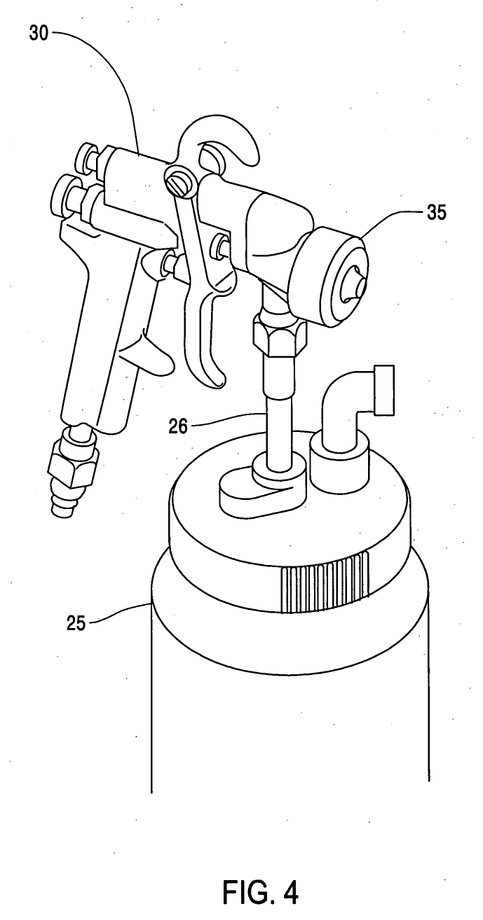

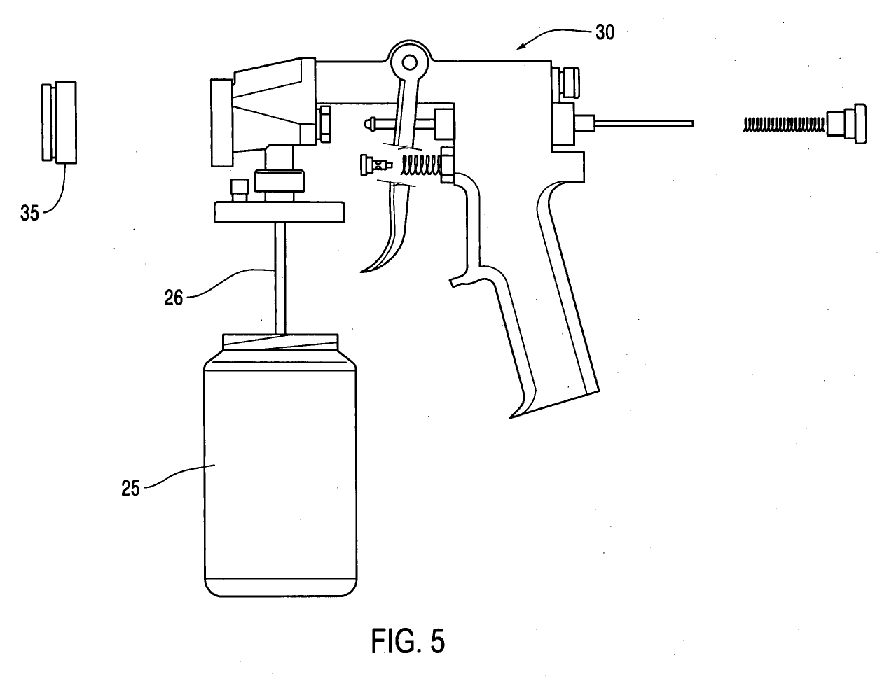

With reference to FIGS. 4 and 5, in various exemplary embodiments, the dispenser gun 30 and the dry polymer powder holding tank 25 assembly may be a modified COTS paint spray gun with a 1-liter can attached. In other alternative embodiments, a 2-liter can may be used as the dry polymer particle holding tank 25.

Typically, a commercial paint spray gun is used to spray automotive or other paints. In general use, compressed air is passed through an orifice in the spray gun, which draws paint from the can up through a dip tube to the gun assembly and out a nozzle attached to the front of the gun.

In various exemplary embodiments according to this invention, the dispenser gun 30 includes a COTS spray gun that is modified to allow water to be pumped through the dispenser gun 30 instead of air. In order to draw the dry polymer powder from the holding tank 25, the dry polymer powder holding tank 25 is separately pressurized so as to force the dry polymer powder up through a dip tube 26, which is extended into the dry polymer powder holding tank 25, and out the discharge/mixing nozzle 35. The pathway for the dry polymer powder to a dispensing orifice in the discharge/mixing nozzle 35 keeps the dry polymer powder completely separated from the water within the dispenser gun 30.

In various exemplary embodiments, the modified COTS dispenser gun 30 was modified by enlarging the orifice sizes in the dispenser gun 30 to accommodate the water and the dry polymer powder. Modifications to the COTS water tank system include re-routing a high-pressure gas line so that pressurized gas can also be supplied to the dry polymer powder holding tank 25. A pressure regulator (shown as 45 in FIG. 2) was added in the re-routed line to accurately control the pressure in the dry polymer powder holding tank 25.

Generally, the dry polymer powder may include commercially available dry Polyacrylamide; Cytec A-130 anionic flocculant, having a specific gravity, or S.G., of about 0.83 (6.94 lb./gallon). The dry polymer powder is water soluble and generally non-toxic.

In various exemplary embodiments, flow rates of the individual streams may be regulated based at least on one or more of a size, shape, specific gravity and angle of repose of the dry polymer powder. The dry polymer powder may, for example, comprise a particle size distribution by weight of between about 0.1 mm (100 micron) to about 1 mm. In various alternate exemplary embodiments, the dry polymer powder may have a particle size distribution by weight less than about 0.1 mm (100 micron). Preferable, distributions for mean particle size may lie in a range of about 0.025 mm to about 0.500 mm. Exemplary angles of repose for the dry polymer powder may preferably be in a range of about 10 degrees to about 80 degrees. Exemplary specific gravities for the dry polymer powder may lie within the range of about 0.4 to about 1.0.

In various exemplary embodiments, the dry particle powder may contain particles of with shapes that are substantially irregular, substantially spherical, and/or a combination of both substantially irregular and substantially spherical.

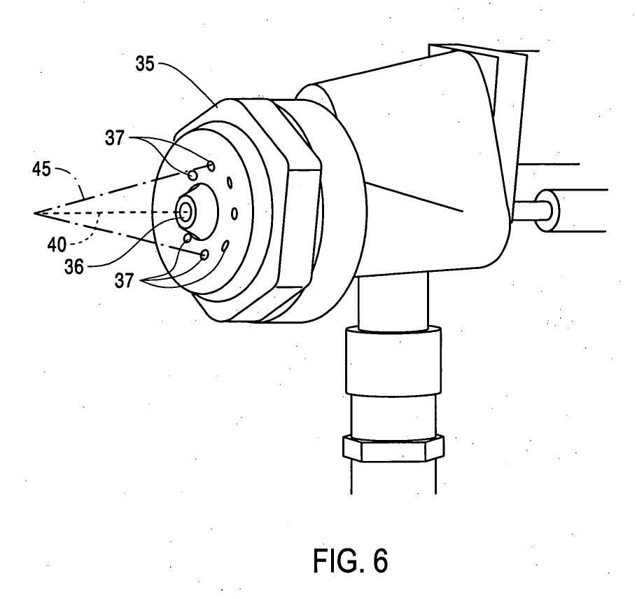

With reference to FIG. 6, throughout the system, the water and the dry polymer powder are kept completely separated from each other until they have both exited the discharge/mixing nozzle 35 of the dispenser gun 30. The discharge/mixing nozzle 35 is designed to seal off the water and the dry polymer powder as they enter the discharge/mixing nozzle 35, keeping them completely separated so that no gelling can occur in the discharge/mixing nozzle 35 or otherwise in the dispenser gun 30. The discharge/mixing nozzle 35 also directs the two materials in converging paths after exiting so that they can then mix outside the discharge/mixing nozzle 35, in the air.

In operation, the man-portable ATM dispensing system 1 provides the means to deliver the correct flow rate (in lb/min.) of the dry polymer powder to the discharge/mixing nozzle 35 by means of air aspiration. Generally, the flow rate of the dry polymer powder is adjustable by setting the air flow rate and the water flow rate separately. In various exemplary embodiments, the ratio of water to dry polymer powder out of the discharge/mixing nozzle 35 ranges from about 7:1 to about 16:1 by weight. In a preferred exemplary embodiment, the ratio of water to dry polymer powder out of the discharge/mixing nozzle 35 is about 10:1 by weight.

It should be noted that the dry polymer powder is very sensitive to moisture. Therefore, the design and configuration of the dry polymer powder holding tank 25 and the dispenser gun 30 allows the dry polymer powder to remain dry prior to exiting the discharge/mixing nozzle 35.

As shown in FIG. 6, in various exemplary embodiments, the discharge/mixing nozzle 35 includes a dry polymer powder dispensing section 36 and a water stream dispensing section 37, which maintain the physical separation of the two material streams, the polymer powder stream 40 and the water stream 45, until the two material streams 40,45 exit the discharge/mixing nozzle 35.

In various exemplary embodiments, the discharge/mixing nozzle 35 may include a firefighting equipment-type nozzle, such as, for example, a dual opening, Hydro-Chem nozzle HCHG-60-1.0 manufactured by Williams Fire & Hazard Control.

As discussed above, the water stream 45 and the dry polymer powder stream 40 each exit the discharge/mixing nozzle 35 simultaneously from two different openings or sections 36,37, shown in exemplary manner in FIG. 6, of the discharge/mixing nozzle 35, mix together per the predetermined ratio by weight per unit time, and then form a gel like ATM prior to, or shortly after being deposited on a horizontal, sloping or vertical surface. The different flow rate(s) of the water and dry polymer powder are each predetermined by the individual dispensing systems.

While the invention has been described in conjunction with the exemplary embodiments described above and depicted in exemplary manner in the Figures, these embodiments should be viewed as illustrative, not limiting. Various modifications, substitutes, or the like are possible within the spirit and scope of the invention.

What is claimed is:

1. A man-portable system for dispensing an anti-traction material on a target surface, comprising:
an anti-traction material dispensing gun having a dispensing nozzle, said dispensing nozzle having a polymer powder steam dispensing section and a separate water stream dispensing section;
a polymer powder dispensing system that provides a polymer powder to the polymer powder dispensing section of the dispensing nozzle; and
a water dispensing system that provides water to the water stream dispensing section of the dispensing nozzle,
wherein a polymer powder stream is mixed with a water stream upon exit of the polymer powder stream and the water stream out of the dispensing nozzle to form the anti-traction material,
the anti-traction material formed on the target surface being a gel.

2. The system according to claim 1, wherein the polymer powder dispensing system comprises:
a polymer powder holding tank; and
a compressed air system that provides motive air to transport the polymer powder from the polymer powder holding tank to the polymer powder stream dispensing section of the dispensing nozzle.

3. The system according to claim 2, wherein the compressed air system controls the amount of polymer powder exiting the polymer powder holding tank.

4. The system according to claim 3, wherein the polymer powder has a mean particle size distribution in a range of about 0.025 mm to about 0.500 mm and an angle of repose in a range of about 10 degrees to about 80 degrees.

5. The system according to claim 3, wherein the anti-traction material dispensing gun controls a flow rate of the polymer powder out of the polymer powder holding tank to correspond to a flow rate of the water that provides a ratio of water to polymer powder in a range of about 7:1 to about 16:1 by weight upon exiting the dispensing nozzle.

6. The system according to claim 1, further comprising a man-portable carrier to which at least the polymer powder dispensing system, the water dispensing system and the dispensing gun are coupled.

7. The system according to claim 1, wherein the water dispensing system, comprises:
a water holding tank; and
a pump to drive the water from the water holding tank to the water stream dispensing section of the dispensing nozzle.

8. A method of dispensing an anti-traction material on a target surface, comprising:
providing a polymer powder to a first section of a dispensing nozzle;
providing water to a second section of a dispensing nozzle; and
mixing a polymer powder stream with a water stream upon exit of the polymer powder stream and the water stream out of the first and second sections of the dispensing nozzle to form the anti-traction material on the target surface,
the anti-traction material formed on the target surface being a gel.

9. The method according to claim 8, wherein a ratio of water to the polymer powder ranges from about 7:1 to about 16:1 by weight upon exiting the dispensing nozzle.

10. The method according to claim 9, wherein a ratio of water to the polymer powder is about 10:1 by weight upon exiting the dispensing nozzle.

11. The method according to claim 8, wherein the anti-traction material can be dispensed on, and adheres to, horizontal, sloping or vertical surfaces.

12. The method according to claim 8, wherein the anti-traction material further comprises additives selected from the group of malodorants, obnoxious chemicals, colorants, and mixtures thereof.

13. The method according to claim 8, wherein the polymer powder comprises acrylic polymer particles having a mean particle size of less than about 0.425 mm.

14. The method according to claim 8, wherein the polymer powder comprises acrylic polymer particles having a mean particle size ranging from about 0.01 mm to about 0.50 mm.

15. The method according to claim 8, wherein the polymer powder comprises acrylic polymer particles having a mean particle shape that is substantially irregular.

16. The method according to claim 8, wherein the polymer powder comprises acrylic polymer particles having a mean particle shape that is substantially spherical.

17. The method according to claim 8, wherein the polymer powder comprises acrylic polymer particles having a specific gravity within a range of about 0.4 to about 1.0

18. The method according to claim 8, wherein the polymer powder has an angle of repose within a range of about 10 degrees to about 80 degrees.
